(19) United States
(12) Patent Application Publication
(10) Pub. No.: US 2019/0131841 A1
(43) Pub. Date: May 2, 2019

(54) ELECTRIC MACHINE AND METHODS FOR DISASSEMBLING AND PRODUCING THE ELECTRIC MACHINE

(71) Applicant: SIEMENS AKTIENGESELLSCHAFT, München (DE)

(72) Inventors: Andrey Mashkin, Köln (DE); Mario Brockschmidt, Essen (DE); Christian Staubach, Marl (DE); Friedhelm Pohlmann, Essen (DE); Guido Schmidt, Leichlingen (DE)

(73) Assignee: Siemens Aktiengesellschaft, Munich (DE)

(21) Appl. No.: 16/095,509

(22) PCT Filed: Mar. 3, 2017
(86) PCT No.: PCT/EP2017/055785

§ 371 Date: Oct. 22, 2018

(30) Foreign Application Priority Data
Apr. 25, 2016 (EP) 16166838.9

(51) Int. Cl. H02K 3/40; H02K 15/00

(52) U.S. Cl. CPC H02K 3/40; H02K 15/0006

(57) ABSTRACT

An electric machine having an electrical conductor, a main insulation surrounding the conductor, an outer corona shield surrounding the main insulation, a laminated core having grooves, into which grooves the conductor is inserted, and an electrically conductive layer, which is arranged radially outside of the outer corona shield and is designed to connect the outer corona shield to the laminated core in an electrically conductive manner. The adhesions of the main insulation, the outer corona shield, the electrically conductive layer, and the laminated core are coordinated with each other in such a way that the lowest adhesion is present at a surface of the electrically conductive layer.

### CROSS REFERENCE TO RELATED APPLICATIONS

This application is the US National Stage of International Application No. PCT/EP2017/055785 filed Mar. 3, 2017, and claims the benefit thereof. The International Application claims the benefit of European Application No. EP16166838 filed Apr. 25, 2016. All of the applications are incorporated by reference herein in their entirety.

### FIELD OF INVENTION

The invention relates to an electric machine, a method for disassembling the electric machine and a method for producing the electric machine wherein electrical conductors of the electric machine are easily removable from the latter.

### BACKGROUND OF INVENTION

A high-voltage machine, such as, for example, a turbogenerator in a power plant for generating electrical energy, is subjected to high mechanical, thermal and electrical stress. The turbogenerator comprises, in particular, a laminated stack and a winding of electrical conductors. The conductors are enveloped by a main insulation, which electrically insulates the conductors vis-à-vis one another, vis-à-vis the laminated stack and vis-à-vis the surroundings. In order to avoid partial discharges at the interface between the main insulation and the laminated stack during the operation of the high-voltage machine, a weakly conducting and grounded outer corona shield is provided between the main insulation and the laminated stack.

In order to produce the high-voltage machine, the laminated stack together with the winding can be immersed in a bath comprising an impregnating resin in a process of impregnation by total immersion with application of vacuum. In this case, the main insulation and the outer corona shield are impregnated by the impregnating resin. After the impregnation, the impregnating resin is cured, in particular with application of pressure.

If the winding is removed from the laminated stack for repair purposes, then residues of the outer corona shield may remain stuck to the laminated stack. Before a new winding is attached to the laminated stack, it is necessary for the residues to be removed from the laminated stack. A mechanical method or a method appertaining to laser technology is conventionally employed for this purpose. However, these methods require a high time expenditure and are thus cost-intensive. Moreover, in the case of these methods there is the risk of damage to the laminated stack.

U.S. Pat. No. 6,140,733 discloses a conductor winding configuration for a large electric machine. WO 97/43817 A1 discloses a conductor winding arrangement for a large electric machine.

### SUMMARY OF INVENTION

Therefore, it is an object of the invention to provide an electric machine, a method for disassembling the electric machine and a method for producing the electric machine wherein electrical conductors of the electric machine are easily removable from the latter.

The object is achieved by the features of the independent claims. Further configurations in respect thereof are specified in the further patent claims.

The electric machine according to the invention comprises an electrical conductor, a main insulation enveloping the conductor, an outer corona shield enveloping the main insulation, a laminated stack having slots, into which the conductor is introduced, and an electrically conductive layer, which is arranged radially outside the outer corona shield and is configured to electrically conductively connect the outer corona shield to the laminated stack, wherein the adhesions of main insulation, outer corona shield, electrically conductive layer and laminated stack are coordinated with one another in such a way that the lowest adhesion is present at a surface of the electrically conductive layer.

As a result of the provision of the electrically conductive layer, when removing the electrical conductor with the main insulation and the outer corona shield from the slots, a separation will take place at the surface of the electrically conductive layer. This prevents residues of the outer corona shield from remaining stuck to the laminated stack. Moreover, the electrical conductor together with the main insulation and the outer corona shield can be removed from the slots more easily than is the case for conventional electric machines.

According to the invention, the electrically conductive layer has a lower electrical resistivity than the outer corona shield. This advantageously ensures that the outer corona shield is electrically connected to the grounded laminated stack and is thus likewise grounded.

It is advantageous for the electrically conductive layer to comprise a lubricating lacquer and/or a tape, wherein the tape comprises Teflon, polyethylene, polyethylene derivatives, polyoxymethylene and/or polyoxymethylene derivatives. In this case, the lubricating lacquer can be applied on the surface of the laminated stack and/or on the radially outer surface of the outer corona shield, for example by spraying. As a result of the provision of the lubricating lacquer and/or the tape, the electrical conductor together with the main insulation and the outer corona shield can be removed particularly easily.

The lubricating lacquer advantageously comprises polyvinyl acetate, epoxy resin, novolac, Teflon and/or novolac epoxy resin. Advantageously, these compounds are not attacked by an impregnating resin during impregnation and do not enter into a chemical reaction with the impregnating resin. As a result, the electrical conductor together with the main insulation, the outer corona shield and the impregnating resin can be removed particularly easily. The lubricating lacquer is advantageously temperature-resistant up to 130° C. As a result, the lubricating lacquer is advantageously not attacked during impregnation. It is advantageous for the lubricating lacquer to comprise graphite. As a result of the graphite the lubricating lacquer is electrically conductive and at the same time has a low adhesion to the outer corona shield and/or to the laminated stack.

It is advantageous for the tape to comprise a coating comprising silicone. The adhesion of the tape to the outer corona shield and/or the laminated stack can advantageously be reduced as a result. The tape advantageously comprises a fabric, in particular a fabric having flat yarns, and/or a film. The flat yarns bring about a good contacting of the fabric with the laminated stack, as a result of which a penetration of the impregnating resin between the fabric and the laminated stack is advantageously reduced. It is advantageous for the fabric to be impregnatable and/or for the film to be perforated and/or wound onto the outer corona shield in such a way that a gap is provided between two adjacent turns. As a result of the provision of the perforation and/or the gap, just like in the case of the fabric the impregnating resin can penetrate radially from outside into the outer corona shield and into the main insulation. The tape advantageously comprises two plies of the film, wherein the film is perforated in such a way that the two plies are perforated in a manner offset with respect to one another. As a result of the provision of two plies, the electrical conductor together with the main insulation and the outer corona shield can be removed particularly easily. Moreover, a reflux of the impregnating resin from the main insulation into the space between the film and the laminated stack is advantageously made more difficult, as a result of which it becomes less likely that the film will stick to the laminated stack.

It is advantageous for the tape to comprise carbon black particles, graphite particles, carbon fibers and/or electrically semiconducting particles, in particular SiC particles, metal oxide particles and/or metal-oxide-coated mica particles and/or aluminum oxide particles. With these particles, the electrical conductivity of the tape can be produced particularly easily. In this case, it is advantageous for the particles to be present in the tape in a percolating manner, which means that they form a continuous network from one planar side of the tape to the other planar side of the tape.

The laminated stack has lamellae projecting into the slots to different extents, wherein only a portion of the lamellae is in contact with the tape, wherein the portion is formed by lamellae projecting far into the slots. A cavity is thus arranged between the other portion of the lamellae and the tape, in which cavity the impregnating resin can spread during impregnation. From the cavity the impregnating resin can then penetrate into the outer corona shield and into the main insulation. It is advantageous for the dimensions of the electrical conductor, of the main insulation, of the outer corona shield and of the slots to be chosen in such a way that the tape is pressed onto the laminated stack. As a result, during impregnation no impregnating resin can penetrate between the lamellae projecting far and the tape, as a result of which sticking between the lamellae projecting far and the tape is provided and the electrically conductive connection of the tape and the laminated stack is maintained even during impregnation.

It is advantageous for the main insulation and the outer corona shield to be impregnated by an impregnating resin and the impregnating resin to be cured, wherein no impregnating resin is situated at locations at which the electrically conductive layer electrically conductively connects the outer corona shield to the laminated stack.

In the method according to the invention for disassembling the electric machine, the electrical conductor, the main insulation and the outer corona shield are removed from the slots, wherein the removing involves separating the outer corona shield and the electrically conductive layer and/or separating the electrically conductive layer and the laminated stack.

The method according to the invention for producing the electric machine comprises the steps of: introducing an electrical conductor, a main insulation enveloping the conductor, and an outer corona shield enveloping the main insulation, into slots of a laminated stack of the electric machine, wherein an electrically conductive layer is provided radially outside the outer corona shield and is configured to electrically conductively connect the outer corona shield to the laminated stack; impregnating the main insulation and the outer corona shield with an impregnating resin; curing the impregnating resin. In this case, the electrically conductive layer can be applied on the laminated stack before the conductor together with the main insulation and the outer corona shield is introduced into the slot. Alternatively, the electrically conductive layer can be applied on the outer corona shield radially on the outside before the conductor together with the main insulation and the outer corona shield is introduced into the slot.

### BRIEF DESCRIPTION OF THE DRAWINGS

Particular embodiments of the electric machine according to the invention are explained below with reference to the accompanying schematic drawings, in which:

FIGS. 1 to 6 show various electric machines according to the invention, and

FIGS. 7 to 9 shows various windings of a film.

### DETAILED DESCRIPTION OF INVENTION

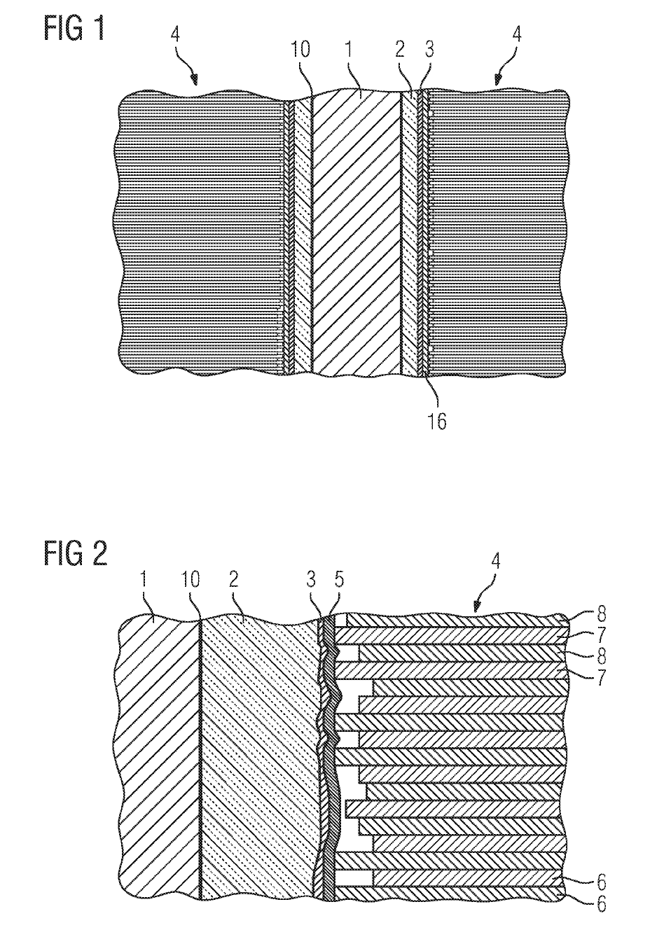

As is evident from FIGS. 1 to 6, an electric machine comprises an electrical conductor 1, a main insulation 2 enveloping the conductor 1, an outer corona shield 3 applied on and enveloping the main insulation 2, and a laminated stack 4, into which slots are introduced. The electrical conductor 1 with the main insulation 2 and the outer corona shield 3 is introduced into the slots of the laminated stack 4. The outer corona shield 3 is weakly electrically conductive and grounded and thus configured to avoid partial discharges between the main insulation 2 and the laminated stack 4. An electrically weakly conductive internal potential control 10 can be provided between the electrical conductor 1 and the main insulation 2 in order to avoid partial discharges between the electrical conductor 1 and the main insulation 2. The laminated stack comprises lamellae 6 projecting into the slots to different extents. The lamellae 6 are differentiated into exposed lamellae 7, which project far into the slots, and set-back lamellae 8, which project into the slots less far than the exposed lamellae 6.

The electric machines in accordance with FIGS. 1 to 4 and 5 comprise an electrically conductive layer 16, which is arranged radially outside the outer corona shield 3 and is configured to electrically conductively connect the outer corona shield 3 to the laminated stack 4. The electrically conductive layer 16 has a lower electrical resistivity than the outer corona shield 3. The adhesions of main insulation 2, outer corona shield 3, electrically conductive layer 16 and laminated stack 4 are coordinated with one another in such a way that the lowest adhesion is present at a surface of the electrically conductive layer 16. What is achieved thereby is that a separation between the electrically conductive layer 16 and the outer corona shield 3 and/or between the electrically conductive layer 16 and the laminated stack 4 takes place when removing the electrical conductor 1 with the main insulation 2 and the outer corona shield 3.

By way of example, the electrically conductive layer 16 can comprise a lubricating lacquer. The lubricating lacquer 16 can be arranged at the surface of the laminated stack 4 and/or at the surface of the outer corona shield 3. The lubricating lacquer comprises polyvinyl acetate, epoxy resin, novolac, Teflon and/or novolac epoxy resin. Furthermore, the lubricating lacquer comprises graphite. It is conceivable for the lubricating lacquer also to be applied on the surface of the electrical conductor 1.

The electrically conductive layers 16 of the electric machines in accordance with FIGS. 2 to 4 comprise an electrically conductive tape 5, wherein the tape 5 comprises Teflon, polyethylene, polyethylene derivatives, polyoxymethylene and/or polyoxymethylene derivatives. For its electrical conductivity the tape 5 comprises carbon black particles, graphite particles, carbon fibers and/or electrically semiconducting particles, in particular SiC particles, metal oxide particles and/or metal-oxide-coated mica particles and/or aluminum oxide particles. The tape 5 can comprise an electrically conductive coating comprising silicone. For its electrical conductivity the coating comprises carbon black particles, graphite particles, carbon fibers and/or electrically semiconducting particles, in particular SiC particles, metal oxide particles and/or metal-oxide-coated mica particles and/or aluminum oxide particles. As is evident from FIG. 2, the main insulation 2, the outer corona shield 3 and, in the case where the tape 5 is provided, the tape 5 can relax in the region of the set-back lamellae 8.

As is evident from FIGS. 2 to 4, only a portion of the lamellae 6 is in contact with the tape 5, wherein the portion is formed by lamellae 6 projecting far into the slots, namely by the exposed lamellae 7. During the production of the electric machine, the impregnating resin 9 can penetrate into the cavities between the set-back lamellae 8 and the tape 5 and can penetrate from there into the outer corona shield 3 and into the main insulation 2. This is illustrated by the path 13 in FIG. 4. The dimensions of the electrical conductor 1, of the main insulation 2, of the outer corona shield 3 and of the slots are chosen in such a way that the tape 5 is pressed onto the laminated stack 4. As a result, during the production of the electric machine, the impregnating resin 9 cannot reach contact points between the tape 5 and the laminated stack. This is illustrated by the path 14 in FIG. 4. During the removal of the electrical conductor 1 together with the main insulation 2 and the outer corona shield 3, the impregnating resin 9 that has penetrated in the cavities between the laminated stack 4 and the tape 5 does not result in any disturbance because the exposed lamellae 7 are free of impregnating resin and a weakened or absent mechanical connection between the tape 5 and the laminated stack 4 is thus ensured.

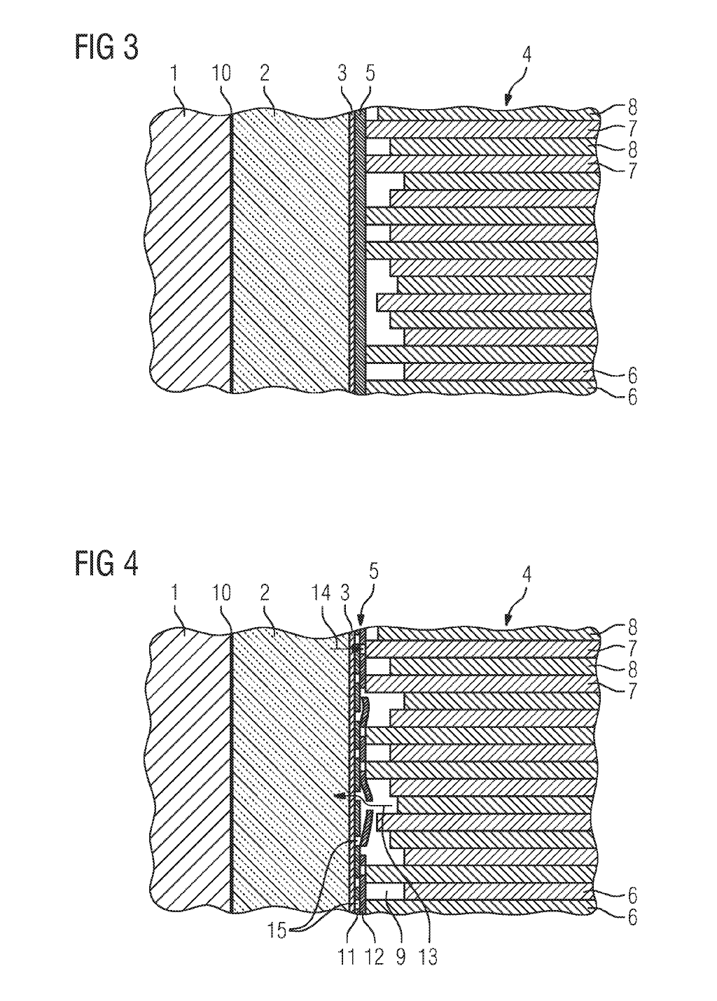

The tape 5 of the electric machine in accordance with FIG. 3 comprises a fabric, wherein the fabric comprises Teflon, polyethylene, polyethylene derivatives, polyoxymethylene and/or polyoxymethylene derivatives. The fabric is fashioned in such a way that it is impregnatable by an impregnating resin 9. The fabric can furthermore comprise flat yarns.

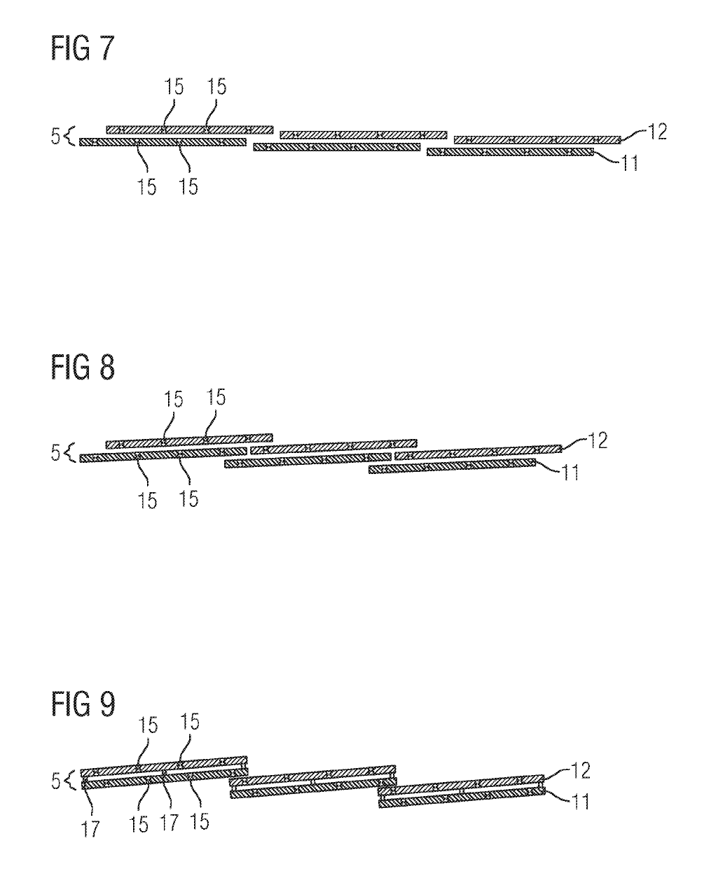

The tape 5 of the electric machine in accordance with FIG. 4 comprises a film, wherein the film comprises Teflon, polyethylene, polyethylene derivatives, polyoxymethylene and/or polyoxymethylene derivatives. In order that impregnation with the impregnating resin 9 can take place, the film is perforated with perforation holes 15 and/or wound onto the outer corona shield 3 in such a way that a gap is provided between two adjacent turns. Some examples of this type are illustrated in FIGS. 7 to 9, wherein the tape can also comprise spot-adhesively-bonded films in accordance with FIG. 9. The electric machine in accordance with FIG. 4 comprises an inner ply 11 and an outer ply 12 of the film, wherein the film is perforated in such a way that the perforation holes 15 of the two plies 11, 12 are arranged in a manner offset with respect to one another.

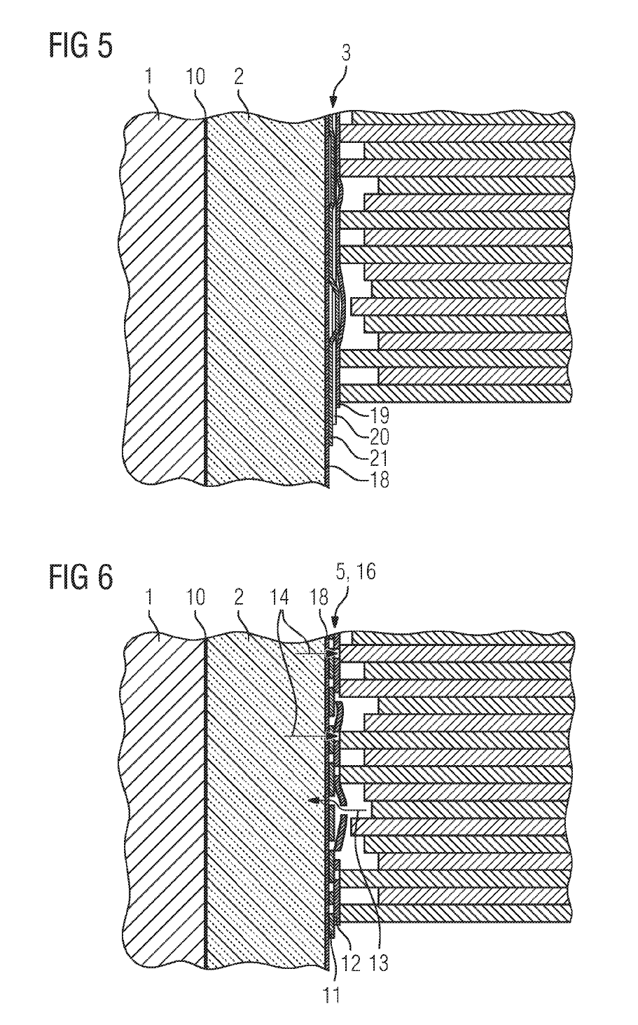

The outer corona shield 3 of the electric machine in accordance with FIG. 5 comprises an outer corona shield inner ply 18 applied directly on the main insulation 2, an outer corona shield outer ply 19 arranged radially outside the outer corona shield inner ply 18, and a mica tape 20 arranged between the outer corona shield inner ply 18 and the outer corona shield outer ply 19. The outer corona shield inner ply 18 and the outer corona shield outer ply 19 are weakly electrically conductive. The mica tape 20 comprises mica, is electrically insulating and brings about a mechanical decoupling of the outer corona shield inner ply 18 and the outer corona shield outer ply 19. In order to electrically connect the outer corona shield inner ply 18 and the outer corona shield outer ply 19, an electrically conductive contact tape 21 is provided, which is arranged alternately radially on the inside and radially on the outside of the mica tape 20. During the removal of the electrical conductor 1 with the main insulation 2 and the outer corona shield 3, a separation will take place in the region of the mica tape 20, as a result of which part of the outer corona shield 3 remains stuck to the laminated stack 4. In order to prevent this, the electrically conductive layer 16 can be provided between the outer corona shield 3 and the laminated stack 4. In the case where the electrically conductive layer 16 is provided, the mica tape 20, the contact tape 21 and the outer corona shield outer ply 19 need not be provided, as a result of which the electric machine has a simple construction. FIG. 6 shows such an electric machine in which the outer corona shield 3 comprises only the outer corona shield inner ply 18. The electrically conductive layer 16 here is formed by the film, wherein two plies 11, 12 of the film are provided.

By way of example, the impregnating resin comprises an epoxy resin. The epoxy resin comprises, for example, bisphenol A diglycidyl ether, bisphenol F diglycidyl ether, phenolic novolacs, aliphatic epoxies and/or cycloaliphatic epoxies. Furthermore, it is advantageous for the epoxy resin to comprise a cyclic carboxylic anhydride, in particular maleic anhydride, phthalic anhydride, methylhexahydrophthalic anhydride and/or hexahydrophthalic anhydride.

By way of example, the main insulation 2 and/or the outer corona shield 3 comprise(s) mica, in particular in the form of a mica paper. For the electrical conductivity of the outer corona shield 3, the mica can be coated with metal oxides, in particular with semiconducting metal oxides.

In one exemplary method for disassembling the electric machine, the electrical conductor 1, the main insulation 2 and the outer corona shield 3 are removed from the slots, wherein the removing involves separating the outer corona shield 3 and the electrically conductive layer 16 and/or separating the electrically conductive layer 16 and the laminated stack 4.

By way of example, a method for producing the electric machine is to be carried out as follows: introducing an electrical conductor 1, a main insulation 2 enveloping the conductor 1, and an outer corona shield 3 enveloping the main insulation 2, into slots of a laminated stack 4 of the electric machine, wherein an electrically conductive layer 16 is provided radially outside the outer corona shield 3 and is configured to electrically conductively connect the outer corona shield 3 to the laminated stack 4; impregnating the main insulation 2 and the outer corona shield 3 with an impregnating resin; curing the impregnating resin.

Although the invention has been more specifically illustrated and described in detail by means of the preferred exemplary embodiments, nevertheless the invention is not restricted by the examples disclosed and other variations can be derived therefrom by the person skilled in the art, without departing from the scope of protection of the invention.

1. An electric machine, comprising:
an electrical conductor,
a main insulation enveloping the electrical conductor,
an outer corona shield enveloping the main insulation,
a laminated stack having slots, into which the electrical conductor is introduced, and
an electrically conductive layer, which is arranged radially outside the outer corona shield and is configured to electrically conductively connect the outer corona shield to the laminated stack,
wherein adhesions of main insulation, outer corona shield, electrically conductive layer and laminated stack are coordinated with one another in such a way that the lowest adhesion is present at a surface of the electrically conductive layer,
wherein the electrically conductive layer has a lower electrical resistivity than the outer corona shield.

2. The electric machine as claimed in claim 1,
wherein the electrically conductive layer comprises a lubricating lacquer and/or a tape, wherein the tape comprises Teflon, polyethylene, polyethylene derivatives, polyoxymethylene and/or polyoxymethylene derivatives.

3. The electric machine as claimed in claim 2,
wherein the lubricating lacquer comprises polyvinyl acetate, epoxy resin, novolac, Teflon and/or novolac epoxy resin.

4. The electric machine as claimed in claim 2,
wherein the lubricating lacquer comprises graphite.

5. The electric machine as claimed in claim 2,
wherein the tape comprises a coating comprising silicone.

6. The electric machine as claimed in claim 2,
wherein the tape comprises a fabric or a fabric having flat yarns, and/or at least one film.

7. The electric machine as claimed in claim 6,
wherein the fabric is impregnatable and the film is perforated and/or wound onto the outer corona shield in such a way that a gap is provided between two adjacent turns.

8. The electric machine as claimed in claim 6,
wherein the tape comprises two plies of the film, wherein the film is perforated in such a way that the two plies are perforated in a manner offset with respect to one another.

9. The electric machine as claimed in claim 2,
wherein the tape comprises carbon black particles, graphite particles, carbon fibers and/or electrically semiconducting particles, SiC particles, metal oxide particles and/or metal-oxide-coated mica particles and/or aluminum oxide particles.

10. The electric machine as claimed in claim 2,
wherein the laminated stack has lamellae projecting into the slots to different extents, wherein only a portion of the lamellae is in contact with the tape, wherein the portion is formed by lamellae projecting far into the slots.

11. The electric machine as claimed in claim 10,
wherein dimensions of the electrical conductor, of the main insulation, of the outer corona shield and of the slots are chosen in such a way that the tape is pressed onto the laminated stack.

12. The electric machine as claimed in claim 1,
wherein the main insulation and the outer corona shield are impregnated by an impregnating resin and the impregnating resin is cured, wherein no impregnating resin is situated at locations at which the electrically conductive layer electrically conductively connects the outer corona shield to the laminated stack.

13. A method for disassembling an electric machine as claimed in claim 1, comprising:
removing the electrical conductor, the main insulation and the outer corona shield from the slots, wherein the removing involves separating the outer corona shield and the electrically conductive layer and/or separating the electrically conductive layer and the laminated stack.

14. A method for producing an electric machine as claimed in claim 1, comprising:
introducing an electrical conductor, a main insulation enveloping the electrical conductor, and an outer corona shield enveloping the main insulation, into slots of a laminated stack of the electric machine, wherein an electrically conductive layer is provided radially outside the outer corona shield and is configured to electrically conductively connect the outer corona shield to the laminated stack;
impregnating the main insulation and the outer corona shield with an impregnating resin; and
curing the impregnating resin.
